(19) United States
(12) Patent Application Publication
(10) Pub. No.: US 2026/0330399 A1
(43) Pub. Date: Oct. 22, 2026

(54) AUTOMATIC SHIPMENT PLAN MODIFICATION

(71) Applicant: Certu Systems, Inc., Pittsburgh, PA (US)

(72) Inventors: Hyong Sok Kim, Pittsburgh, PA (US); Oguzhan Karaahmetoglu, Pittsburgh, PA (US)

(21) Appl. No.: 19/181,875

(22) Filed: Apr. 17, 2025

(51) Int. Cl. G06Q 10/083

(52) U.S. Cl. CPC G06Q 10/0843; G06Q 10/0838

(57) ABSTRACT

One embodiment provides a method, the method including: receiving, utilizing a shipment plan modification system, a shipment plan, wherein the shipment plan includes at least one transportation order for at least one object; identifying, utilizing the shipment plan modification system, at least one condition is being met within the shipment plan, wherein the at least one condition indicates the shipment plan needs to be modified; obtaining, utilizing the shipment plan modification system, software code corresponding to the at least one condition, wherein the software code includes software code that is configured to modify the shipment plan; and automatically modifying, by executing the software code, the shipment plan. Other aspects are claimed and described.

### BACKGROUND

Logistics is the process of managing how objects are obtained, stored, and transported to a final destination of the object. The transportation of objects includes transportation from a manufacturing facility to a destination where objects might be utilized by different companies or entities. The transportation also includes storing objects within warehouses until a final location is identified. The warehouses provide a buffer for the storage of objects that can fulfill a demand while new quantities of the object are manufactured. Thus, an entity may be able to order an object and receive it within a short period of time as opposed to having to wait until the object is manufactured. To get objects from one location to another, for example, from a manufacturing location to a warehouse, from a warehouse to another warehouse, from a warehouse to a final location, and/or the like, different transportation modes may be utilized. Different transportation modes may include boats, airplanes, trucks, and/or the like. These transportation modes allow for the transportation of many different goods at the same time, which is particularly useful for the movement of large amounts of objects from one location to another.

In summary, one aspect provides a method, the method including: receiving, utilizing a shipment plan modification system, a shipment plan, wherein the shipment plan includes at least one transportation order for at least one object; identifying, utilizing the shipment plan modification system, at least one condition is being met within the shipment plan, wherein the at least one condition indicates the shipment plan needs to be modified; obtaining, utilizing the shipment plan modification system, software code corresponding to the at least one condition, wherein the software code includes software code that is configured to modify the shipment plan; and automatically modifying, by executing the software code, the shipment plan.

Another aspect provides a system, the system including: a processor; a memory device that stores instructions that, when executed by the processor, causes the system to: receive, utilizing a shipment plan modification system, a shipment plan, wherein the shipment plan includes at least one transportation order for at least one object; identify, utilizing the shipment plan modification system, at least one condition is being met within the shipment plan, wherein the at least one condition indicates the shipment plan needs to be modified; obtain, utilizing the shipment plan modification system, software code corresponding to the at least one condition, wherein the software code includes software code that is configured to modify the shipment plan; and automatically modify, by executing the software code, the shipment plan.

A further aspect provides a product, the product including: a computer-readable storage device that stores executable code that, when executed by a processor, causes the product to: receive, utilizing a shipment plan modification system, a shipment plan, wherein the shipment plan includes at least one transportation order for at least one object; identify, utilizing the shipment plan modification system, at least one condition is being met within the shipment plan, wherein the at least one condition indicates the shipment plan needs to be modified; obtain, utilizing the shipment plan modification system, software code corresponding to the at least one condition, wherein the software code includes software code that is configured to modify the shipment plan; and automatically modify, by executing the software code, the shipment plan.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example device.

FIG. 2 illustrates an example method for automatically modifying a shipment plan by executing software code and in response to identifying that the shipment plan includes one or more conditions that indicate the shipment plan needs to be modified.

### DETAILED DESCRIPTION

In a product lifecycle, the product or object is generally moved from one location to another. Some of these locations include the manufacturing facility and warehouses or product storage locations that store the products or objects until they are needed or desired. When the product or object needs to be moved, a transportation order is created to move the object from the current location to the target location. Frequently, a logistics company will take care of creating a shipment plan from one or more transportation orders. The logistics company will receive the transportation order which identifies what object is to be moved, an amount of the object to be moved, and a destination of the object. The transportation order may include additional information including, but not limited to, a preferred origin location, a preferred transporter, and/or the like.

From the transportation order(s), an entity will create a shipment plan that details all the relevant information that will be needed to move the object from an origin location to a destination location. The relevant information may include everything from the type of transportation vehicle, to the route that should be taken to transport the object. The relevant information may also identify how long the transportation will take, any inventory constraints, any transportation constraints, and/or the like. The shipment plan may include a single transportation order or may include multiple transportation orders for multiple objects that may be included on the same route, on the same transportation vehicle, the same objects being delivered to multiple locations or picked up from multiple locations, and/or the like.

Once the shipment plan is generated, it is transmitted to the company that will actually effectuate the transportation of the object. This company or entity may be the one that dispatches transportation vehicles, the company or entity that is holding the objects for transport, and/or the like. This company or entity reviews the shipment plan and determines if any changes need to be made to the shipment plan. For example, the entity may decide to use a different transportation vehicle to transport the objects. If the entity determines that changes need to be made, the entity will make the changes to the shipment plan and then execute the shipment plan. This process is a manual process where the entity identifies the modifications to be changed and then makes the modifications to the shipment plan. The shipment plan is generally created from master data that identifies all the constraints on inventory, transportation, and/or the like, that need to be followed for the transportation.

However, the master data may not always be the most reflective of reality or may not take into account certain conditions. Thus, the modifications that are made to the shipment plan by an entity may be based upon different factors, for example, the master data being incorrect or outdated, certain conditions that cause modifications but that are not always present, and/or the like. One issue with a user having to manually make modifications to the shipment plan is that it takes time and effort to make the modifications. Additionally, not all users may know of changes that need to be made. For example, if a single person is usually the person who reviews and makes modifications to shipment plans within an entity, if someone else has to step into that role, this new person may not know of conditions that would result in modifications needing to be made to the shipment plan. Thus, this could result in shipment plans that cannot be executed correctly or fully, thereby causing delays in object shipments for not only the objects of the shipment plan, but other objects that may have been reliant on the accurate and prompt execution of the shipment plan.

Accordingly, the described system and method provides a technique for automatically modifying a shipment plan by executing software code and in response to identifying that the shipment plan includes one or more conditions that indicate the shipment plan needs to be modified.

Therefore, a system provides a technical improvement over traditional methods for the transportation of objects. The described shipment plan modification system provides a technical improvement to the transportation technological field. Millions of tons of freight are transported in the United States each day. Inefficiencies in the transportation field cause delays, causes orders to take longer to transport, and causes many headaches for companies who want freight transported, companies who are trying to receive freight, and companies who are tasked with transporting the freight. The transportation of objects is becoming more and more reliant on computing systems to create shipment orders and determine the best plan for transporting objects in order to reduce these inefficiencies. These computing systems are deficient for the transportation of objects for multiple reasons. One issue is caused due to the fact that the computing system relies on a database in order to create shipment plans. The database includes the information that would be necessary to generate a shipment plan. However, this information is not always the most up-to-date information and/or may not reflect certain conditions. Making changes to these shipment plans relies on manual steps performed by human operators, which can result in inefficiencies in the transportation field.

The described system is able to cause software code to be generated to make changes to shipment plans automatically when conditions are identified and met that correspond to a change. Thus, instead of needing the master data that is stored within a data repository to be updated to reflect these changes, the system is able to utilize code that causes the changes to be made to the shipment plan automatically. Since the shipment plan is generated by a computer system utilizing information stored within a data repository, the issue has necessarily become a computer problem that requires a computing solution, which is what is provided by the described system. The use of the computing system to identify changes that need to be made to the shipment plan, access software code that is configured to make the changes, and then automatically execute the software code to make the changes to the shipment plan, results in a much faster transportation computing system that is able to create accurate shipment plans that reflect reality, thereby significantly improving the transportation technological field by reducing some of the inefficiencies in the process and allowing for an improved transport of the millions of tons of freight in the United States each day.

The illustrated example embodiments will be best understood by reference to the figures. The following description is intended only by way of example, and simply illustrates certain example embodiments.

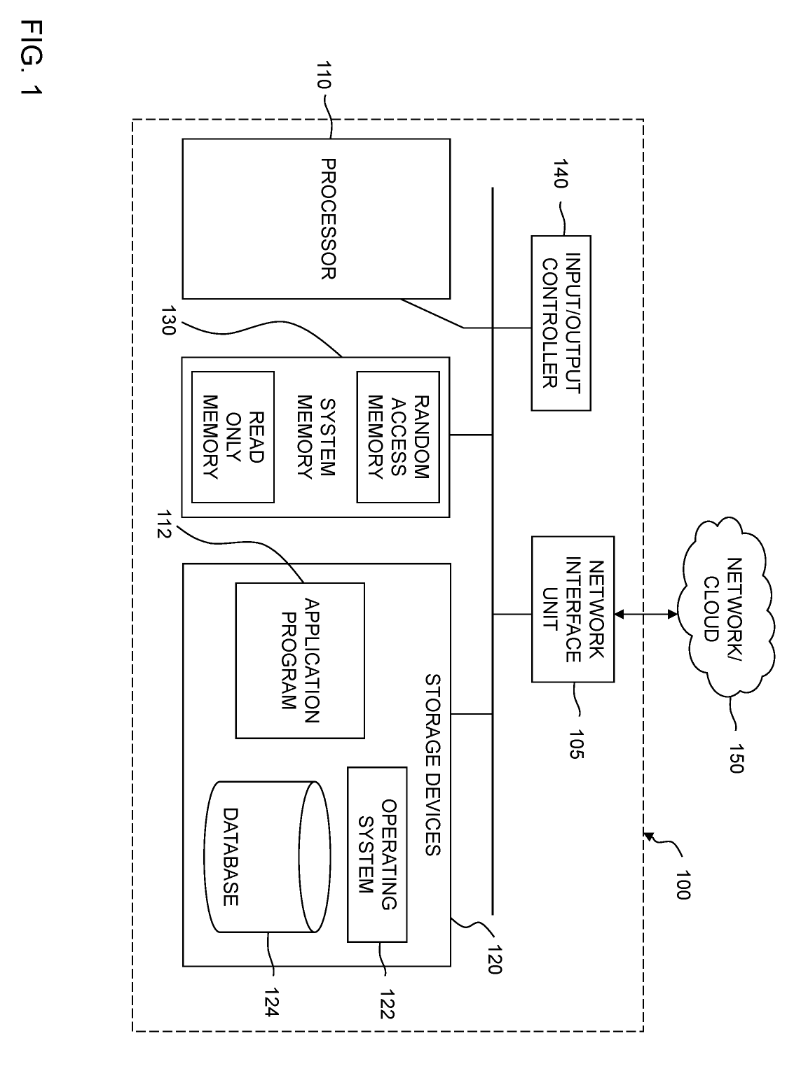

While various other circuits, circuitry or components may be utilized in the described system, an example is illustrated in FIG. 1. In the example of FIG. 1, storage devices 120 includes software such as a workflow graphical user interface application program 112 that may be run or executed by processor(s) 110 according to an operating system 122. The circuitry 100 provides that the processor 110 loads the operating system 122 and thereafter the application program 112, e.g., into memory 130.

System 100 typically includes a network interface 105 facilitating communications with other devices, e.g., a connection to other devices over a network 150 (which may include a local network, remote network, cloud network, etc.) using components such as a WWAN transceiver, a WLAN transceiver or a wired connection, e.g., a LAN connection. Commonly, system 100 will include an input/output controller 140 for data input and display. System 100 typically includes various memory 130 and storage devices 120, for example a database 124, e.g., for storing data from internal and external data sources, referred to herein.

Device circuitry, as for example outlined in FIG. 1, may be used to generate, manage, and process data collected during the operation of the program. It will also be apparent that circuitry other than the non-limiting example outlined in FIG. 1 may be used. Information handling device circuitry, as for example outlined in FIG. 1, may be used in devices such as tablets, smart phones, personal computer devices generally, electronic devices, and/or the like, that may interface with the shipment ordering system, be a part of the shipment ordering system, and/or utilized by users, including transporters, to access information provided within or by the shipment ordering system.

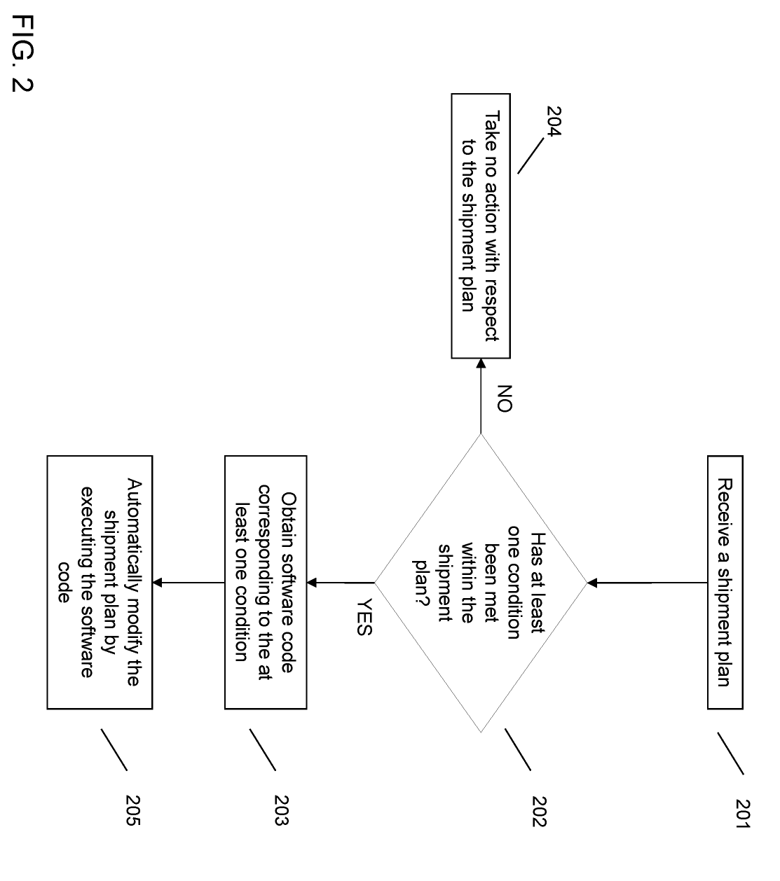

FIG. 2 illustrates an example method for automatically modifying a shipment plan by executing software code and in response to identifying that the shipment plan includes one or more conditions that indicate the shipment plan needs to be modified. The method may be implemented on a system which includes a processor, memory device, output devices (e.g., display device, etc.), input devices (e.g., keyboard, touch screen, mouse, microphones, sensors, biometric scanners, etc.), image capture devices, and/or other components. While the system may include known hardware and software components and/or hardware and software components developed in the future, the system itself is specifically programmed to perform the functions as described herein to automatically update a shipment plan having fulfilled conditions. Additionally, the shipment plan modification system includes modules and features that are unique to the described system.

The shipment plan modification system may be utilized to automatically modify shipment plans. In order to utilize the shipment plan modification system, the system may be activated, either as a standalone application, as a module that works with another application, and/or the like, or a combination thereof. The system may be automatically activated by an application that provides instructions to the system or may be manually activated by a user providing input to the system. The automatic activation of the shipment plan modification system may be based upon the detection of a trigger event indicating that the system should be activated. Example trigger events include identification that an object is to be transported, identification of conditions to a modification, identification of receipt of a shipment plan, activation of software or an application utilizing the shipment ordering system, and/or the like.

The shipment plan modification system may be made of multiple systems or modules that communicate together to make up the shipment plan modification system or may be a single system. The shipment plan modification system may be a system within an organization, for example, a logistics organization, a supplier, and/or any other organization that may arrange transport of objects. The shipment plan modification system may communicate with other systems within the organization and may also communicate with other systems outside the organization, for example, systems of other entities that may transmit transportation requests (e.g., organizations that want transportation objects transported, etc.), inventory control organizations, transportation request generation organizations, systems or devices corresponding to users or people that are involved in the transportation of objects (e.g., transporter devices, transportation vehicle devices, shipper devices, receiver devices, etc.), and/or the like. Thus, the shipment plan modification system may include components or modules that allow for the communication between the shipment plan modification system and the internal and/or external systems. These components or modules may be all located on a single computing device or single computing system, or different components or modules of the system could be located across multiple computing devices or multiple computing system.

The shipment plan modification system may be a standalone system, may be accessible through other computing devices, and/or a combination thereof. For example, the shipment plan modification system may be a standalone system that can be accessed by a user and/or may be or provide an application that is accessible by a user on another computing device. The shipment plan modification system may be accessible using any type of computing device, for example, personal computer, laptop computer, smartphone, tablet, smartwatch, head-mounted display, smart television or other smart appliance, augmented reality device, virtual reality device, and/or the like.

Thus, the shipment plan modification system may be accessible locally using a computing device where the shipment plan modification system is installed and/or may be accessible remotely through another computing device. For example, the shipment plan modification system may be accessed by a user using a device that communicates with the shipment plan modification system to receive shipment plans, modify shipment plans, and/or the like. However, the shipment plan modification system may be located and operate on a different information handling device to perform the described steps. For example, the shipment plan modification system may be located and operate on a cloud computing device, a computing device accessed through a remote network, a computing device accessed through a local network, and/or the like, or a combination thereof.

The shipment plan modification system may have an associated graphical user interface. The graphical user interface may be provided on a display or monitor, which may or may not be associated with the shipment ordering system. In other words, the shipment plan modification system may have a dedicated display or monitor or may be accessible using any display or monitor. In either case, the shipment plan modification system may provide instructions to generate and display the graphical user interface on the display device being used to access the shipment ordering system. The graphical user interface may also be updated and managed based upon instructions provided by the shipment ordering system. In other words, the shipment plan modification system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the shipment plan modification system. For example, the shipment plan modification system may utilize historical information, shipment plan information, transporter information, origin location information, destination location information, inventory information, and/or the like, to receive shipment plans, identify conditions that indicate a modification is needed to the shipment plan, identify values or attributes of the shipment plan that result in changes to shipment plans, obtain software code to modify the shipment plan, modify the shipment plan, and/or the like. The graphical user interface may allow for creation of or access to these profiles, historical information, and/or the like, by allowing a user to input information regarding the shipment plans, inventory constraints, transportation constraints, changes to shipment plans, and/or the like. As will be discussed in more detail, the use of user provided information is not the only way that the stored information can be created. The shipment organization system can then utilize these inputs to store the historical information, identify modifications to shipment plans need to be made, modify shipment plans, and/or the like.

A user could also use the graphical user interface to adjust information stored within the system, make changes to generated shipment plans, access information utilized to generate the shipment plan, make changes to software code that makes modifications, and/or the like. Additionally, or alternatively, the user can input a location of information related to the information, provide a file corresponding to the information or portion thereof, and/or the like, within the graphical user interface. Input may be provided by the user using any type of input modality, including, but not limited to, mechanical input (e.g., keyboard input, mouse input, etc.), touch input, audible or voice input, gesture input, haptic input, thought input, and/or the like.

The graphical user interface may also provide displays that display different information that is utilized by the system, output by the system, generated by the system, and/or the like. It should be noted that the information to be used by the shipment plan modification system and information provided by the shipment plan modification system can be different for different applications, different computing systems, different users, and/or the like. Thus, the information corresponding to input or output of the shipment plan modification system are not always the same. However, the shipment plan modification system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The shipment plan modification system may utilize one or more artificial intelligence models in receiving shipment plans, identifying conditions are met within the shipment plan, obtaining software code for the condition, modifying shipment plans, and/or any other steps included in the system or method. Artificial intelligence models may also be used for steps within a step. For example, a model could be utilized to identify values or attributes that should be applied as a condition in order to identify that at least one condition is being met, generate software code to be used to modify shipment plans, and/or the like.

For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model that is fine-tuned for the shipment plan modification system or may be a model that is created from scratch. Since the shipment plan modification system is used in conjunction with automatically updating shipment plans based upon conditions being met, some models that may be utilized by the system are text analysis models, image analysis models, other analysis models, optimization models, similarity identification models, large language models, language models, filtering models, classification models, mapping models, and/or the like. The model may be trained using one or more training datasets.

Additionally, as the model is deployed, it may receive feedback to become more accurate over time. Alternatively, or additionally, the model may utilize inputs provided to the model to learn continually, thereby using the inputs to make subsequent predictions or using the inputs within the subsequent predictions. The feedback or inputs may be automatically ingested by the model as it is deployed. For example, as the model is used to perform the described method, if a user modifies predictions that were made by the model, provides feedback regarding a prediction, or otherwise provides some indication that the predictions or selections made by the model may be incorrect, the model may ingest this feedback to refine the model. Alternatively, or additionally, the user can provide additional content that should be used to be further train, retrain, or refine the model.

On the other hand, as the model makes predictions in connection with performing the described steps, and no changes are made to the resulting prediction, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, active learning, transfer learning, weak supervision, data augmentation, weakly supervised learning, and/or the like. Accordingly, the training dataset may include annotated data, unannotated data, and/or the like, or a combination thereof.

Whether the model automatically ingests feedback during deployment or not may be determined by a user, author, and/or entity that has deployed the model. Automatic learning by the model may be useful in some applications, but may be detrimental in other applications. Accordingly, a user may make a determination regarding the trainability of the model during deployment. Regardless of whether the model can be retrained during deployment or is only retrained upon instruction by a user, the feedback or inputs could be stored within a data store and utilized at a later time to train or retrain the model. For example, a user could use the feedback to update a training dataset to train or retrain the model.

The feedback or inputs could also be stored within the data store and then be used by the model for updated training. This may be done, for example, in an unsupervised learning session that allows the model to learn patterns and information regarding the training dataset without the need for human supervision, thereby providing at least a partially automated technique for the model to become updated. However, the model may or may not perform this retraining without a human providing input to the model to perform the retraining. In other words, retraining of the model may be based upon how the model is programmed and whether the model is updated while it is deployed or is only updated during a training mode may be based upon that programming.

The AI model may also include a guardrail. The guardrail is a protocol and tool that ensures the AI model operate as intended by the AI model author or owner. The guardrail ensures that the model operates within defined boundaries and principals. The guardrail may be utilized to perform an initial determination regarding whether the AI model is allowed or authorized to respond to a query, allowed or authorized to make a determination, and/or the like. In other words, the guardrail acts as a gatekeeper to the full processing of the AI model. If the guardrail rejects a query or determination request, then the AI model will not be employed to respond or make the determination. On the other hand, if the guardrail approves a query or determination request, then the query or determination request is provided to the AI model for processing. As an example, a query or determination request may be rejected if the information is not valid, if an unauthorized user is making the query or request, if the AI model is unable to respond to such queries or requests, and/or the like.

As previously mentioned, an ensemble of models or multiple models may also be utilized. Some example models that may be utilized are variational autoencoders, generative adversarial networks, recurrent neural networks, convolutional neural networks, deep neural networks, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model. Additionally, the feature sets, vectors, layers, outputs, and/or other characteristics of the model may be chosen by a user based upon the application.

The shipment plan modification system may include different components for carrying out different functions of the system, including different steps to be performed. These components may be hardware components or software components. Some hardware devices or components that may be utilized by the shipment plan modification system include input devices that may be utilized to receive input from the user, for example, mechanical input modalities (e.g., keyboard, mouse, etc.), touch input devices, gesture input devices, electromyography input devices, audio input devices, biometric input devices, and/or the like. Other hardware components may be utilized to provide output from the shipment ordering system. For example, the shipment plan modification system may include speakers, displays or monitors, haptic output devices, audio output devices, and/or the like.

Other hardware components may be included to capture images, for example, an image capture device, screen capture devices, and/or the like. Other hardware components may include data storage devices, including on devices of the user (e.g., mobile device, personal computer, laptop, tablet, smart watch, etc.), devices or components of the shipment plan modification system, and/or the like. The shipment plan modification system may also interface with hardware components of a device. For example, instead of the shipment plan modification system including a display, the shipment plan modification system may provide instructions to display content on a display component of a user device that is employing or communicating with the shipment plan modification system.

One software component may include a data storage location or data repository that stores information related to content of an individual, user profiles, historical information, and/or the like. Information may be stored in the data storage location using any data storage technique. Additionally, the system can access the information stored within the data storage location using any type of querying technique, filtering technique, and/or the like. The information contained within the data storage location may also be organized, for example, grouped by user, grouped by content type (e.g., spoken content, written content, image content, video content, etc.), grouped by data type, grouped by shipment plan, grouped by modification type, and/or the like. The information stored within the data repository may be indexed or grouped based upon multiple identifiers or other characteristics. Thus, the data repository can allow for filtering and sorting.

Another software component includes a master data repository. The master data repository can include any conceivable information that is related to the transportation field. Such information may be related to inventory constraints, transportation constraints, destination constraints, and/or the like. The information within the master data repository includes information that is utilized to generate shipment plans. Thus, the information can be any information that is related to the transportation of objects and that can be used when generating a shipment plan. A shipment plan may identify objects to be transported, origin locations for the objects, destination locations for the objects, transporters for operating transportation vehicles, transportation vehicles for transporting the objects, and/or the like. Some of this information may be stored in or pulled from one or more profiles accessible by the shipment plan modification system.

Inventory constraints may identify locations where inventory of the transportation objects is located (e.g., a warehouse, a manufacturing facility, etc.), identify how much of the transportation object is located at each location, identify when a transportation object will expire (if applicable), identify when a transportation object was placed at a particular location, identify how frequently the transportation object is replenished at a location, identifiers for transportation objects (e.g., product names, stock keeping unit (SKU) identifiers, barcodes, sizes of products, volumes of products, how products fit on a pallet, how products fit in a case, etc.), and/or the like. Thus, the inventory constraints may identify any information related to the objects themselves and locations of the objects.

Transportation constraints may identify information related to a transporter or transportation vehicle for a schedule of the transporter, regulations applicable to a transporter (e.g., a maximum number of working hours for a predetermined time frame, a required number of rest hours, route restrictions, etc.), whether the transporter works on a team, preferences of the transporter (e.g., preferred origin or delivery locations or regions, preferred load types (e.g., van loads, flatbed loads, tarped loads, less-than-a-load loads, multiple stop loads, etc.), preferred delivery routes, preferred delivery durations, etc.) transportation vehicle specifications, current routes of a transporter, current locations of a transporter, transportation vehicle identifiers, transporter identifiers, and/or the like. Thus, the transportation constraints may identify any information related to the transporter and transportation vehicle.

Destination and/or origin locations constraints may identify a preferred delivery schedule, preferred transporters, destination locations, a preferred frequency of delivery, any restrictions (e.g., restrictions regarding other objects that can be co-located on transportation vehicle with the object, regulations applicable to particular objects, how quickly objects need to be delivered, etc.), hours of operation, hours that goods or transportation objects can be picked up or delivered (e.g., only during business hours, only after hours, a subset of business hours, a range of hours, certain days, etc.), types and sizes of trucks or transportation vehicles that can access the origin/destination location, equipment available for use at the origin/destination location (e.g., forklift, hand carts, loading dock types, pallets, cranes, etc.) and a schedule of the equipment availability, employees that can release transportation objects and a schedule of these employees, preferences of the origin/destination location (e.g., preferred transporters, preferred pick up schedules, preferred frequency of order pick up, etc.), inventory delivery schedules, and/or the like. Thus, the destination and/or origin locations constraints may identify any information related to the origin locations and destination locations.

It should be noted that while most data within the master data may be static and does not change frequently, some data may change. For example, inventory constraint information may change as inventory changes. As another example, schedules of transporters may vary and may, therefore, change. Thus, the data in the master data may change in real-time. However, traditionally, these changes are dictated by inputs to the system and are not based upon executions of shipment plans. Additionally, it should be noted that the types of information that are stored within the system or accessible to the system is not strictly limited to the types of information that have been discussed as it can be readily understood that other information may be useful and utilized. Thus, the described information is only for illustrative purposes and is not intended to be limiting to only that information described.

At 201, the shipment plan modification system receives a shipment plan for at least one object. The shipment plan is generally generated using the master data and includes at least one transportation order for the at least one object. It should be noted that a single transportation object will be discussed herein for ease of readability. However, the shipment plan may include may transportation objects, multiple different types of transportation objects, objects being transported to different locations, objects being transported from different locations, on a route having multiple stops, and/or the like. A transportation object can be any type of product or object that can be transported from one location to another utilizing a transportation vehicle. Thus, transportation objects may include, but are not limited to, furniture, people, petroleum products, gas products, liquid products, food objects, office products, paper products, clothing, household objects, electronics, medical objects, and/or the like. Additionally, for ease of readability, a transportation object may also be referred to as an object or product. However, these terms are not intended to limit the transportation object in any way.

A transportation order may be based upon a transportation request that is received by the shipment plan modification system or a system in operative communication with the shipment plan modification system, for example, another system of a logistics organization. The transportation request may be transmitted by another system, for example, another system internal to the organization employing the shipment ordering system, another system that is external to the organization employing the shipment ordering system, and/or the like. For example, a company may want to have transportation objects transported to a destination location. This company may then transmit a transportation request to a logistics organization that coordinates the transportation of the transportation object.

The transportation request may identify a transportation object, an amount of the transportation object that needs to be transported, and a destination location for the transportation object. The transportation request may also identify to where the transportation object is to be delivered, which is referred to as the destination location. It should be noted that it is possible to have multiple destination locations for either portions of the same transportation object or for different objects that are on the same transportation vehicle. Multiple destinations for the same transportation vehicles are generally referred to as multi-stop routes. Loads that take up less than the entirety of a transportation vehicle are generally referred to as less-than-a-load (LTL) loads. With these loads, logistic companies often try to add multiple LTL loads together to make a full load for the transportation vehicle. Such LTL loads may require the transportation vehicle to access multiple origin locations, meaning the vehicle may pick up different LTL loads at different origin locations. Alternatively, in the case of the origin location being a warehouse that houses objects from many different suppliers and for many different customers, the vehicle may be able to pick up different LTL loads all at the same origin location.

The transportation request may also include additional information, for example, an origin location, a requested delivery time and/or date, a schedule for the transportation request, a customer associated with the transportation request, an applicable supplier, any requests associated with the transportation request, restrictions associated with the transportation object (e.g., a stacking height, loading type restrictions (e.g., fork lift loading, hand loading, etc.), restrictions against loading with other objects (e.g., cannot be loaded with other food items to maintain Kosher requirements, cannot be loaded with combustible materials, can only be loaded with other products of the same type, cannot be loaded with other loads, etc.), load size restrictions, etc.), load cover requirements (e.g., van or box, tarped, open, chained, etc.), a preferred transportation vehicle type, and/or the like.

From the transportation request, a system can generate a transportation order for the object(s) of the transportation request. The transportation order(s) can then be used to generate a shipment plan. The shipment plan identifies the details regarding how the objects will be transported from an origin location to a destination location. The transportation orders may include the details for the transportation of objects for a part of the shipment plan. For example, a transportation vehicle that will be transporting multiple object types may have transportation orders for each of the object types that are being transported. The combination of these transportation orders makes up the shipment plan. However, a shipment plan may be created for a single transportation order. From the transportation orders, the system can generate a shipment plan which is an aggregation of the transportation orders, which may be a single transportation order. The shipment plans are generated in view of the master data. In other words, the master data drives the generation of the shipment plan and takes into account any constraints. The resulting shipment plan designates when, where, and how transportation objects are to be transported so as to reduce inefficiencies in the transportation of the objects.

Additional information related to the transportation request, the generation of transportation orders, and the generation of shipment plans, can be found in commonly owned application having serial number 18/947,887, entitled “Transportation Optimization”, and filed on Nov. 14, 2024, the contents of which are incorporated by reference herein as if they were fully set forth herein.

Receipt of the shipment plan at the shipment plan modification system may be done using any available data receipt technique. For example, the shipment plan may be received through the graphical user interface, via a hardware component (e.g., fax machine, printer, etc.), through a software application, through a digital communication medium (e.g., email, instant message, video conferencing system, etc.) either directly, as an attachment, or as a link, and/or the like. Additionally, the shipment plan may be transmitted to the shipment plan modification system using any available data transmission technique. For example, the shipment plan can be uploaded to an application, provided as a link to a data storage location containing the shipment plan, provided as an attachment, and/or the like.

At 202, the shipment plan modification system determines if at least one condition has been met within the shipment plan. In other words, the shipment plan modification system identifies if at least one condition is being met within the shipment plan. The at least one condition indicates that the shipment plan needs to be modified. For ease of readability, a single condition being met will be used as the example here throughout. However, it should be understood that multiple conditions may be met within the shipment plan. In this case, the system performs the described steps with respect to each condition that is met. This identification and processing of conditions and automatic modification, in the event that conditions are met, may occur in parallel, or simultaneously, where multiple modifications are made to the shipment plan at the same time. Alternatively, or additionally, the identification and processing of conditions and automatic modification may occur sequentially where one condition is processed with modifications being made and then the next condition is processed with modifications being made. A combination of parallel and sequential processing may occur and the type of processing (e.g., parallel, sequential, etc.) may be dependent on the type of condition and/or the type of modification that is required to the shipment plan.

The conditions may be stored within a data storage location or data repository. It should be noted that the conditions may be stored in more than one data repository. Additionally, within the data repository or repositories, the conditions may be grouped or organized for later access. The conditions identify values or attributes that correspond to changes or modifications to shipment plans. Thus, the conditions identify the values or attributes and also the modification. If the values or attributes of the condition are met, then the modification identified by the condition will be made. Accordingly, the condition can be stored as a software coding expression, values and results, rule sets, and/or the like. The conditions may be manually placed within the data repository, may be learned by the system and stored, may be default conditions, and/or the like.

The conditions may be specific conditions, for example, a specific attribute or attribute value that corresponds to a specific modification, or may be general conditions, for example, a general attribute or general attribute value that corresponds to a modification. As an example of a specific condition, the condition could identify that a shipment plan having a specific receiver at a destination corresponds to making a change to the delivery hours. This would result to changes in shipment plans that have that specific receiver. As an example of a general condition, the condition could identify those receivers within a particular geographic region correspond to making a change to the delivery hours. This would result to changes in all shipment plans that are received within that geographic region. The system can access the data storage location or data repository that includes the plurality of conditions and identify that the shipment plan has a requirement or values and/or attributes that meet at least one of the conditions of the plurality of conditions.

Determining if at least one condition has been met within the shipment plan may include identifying values and attributes of the shipment plan. The values and attributes of the shipment plan refer to the information that is contained within the shipment plan. For example, the information may include the transporter, the origin location, the destination location, the route speed, identification of toll booths or weigh stations, transportation vehicle type, transportation vehicle identification, hours of operation, and/or the like. In other words, the information may include any of the information contained within the master data that was used to create the shipment plan, inventory constraints, transportation constraints, information added to the shipment plan by a user or entity, and/or the like. The values and attributes of or contained within the shipment plan may be then compared to attributes or values of or corresponding to a condition, rule, and/or the like. If the values and/or attributes of the shipment plan match a condition, then the system identifies that a modification should be made to the shipment plan. Thus, determining at least one condition has been met may include performing a comparison of attributes or values of the shipment plan to values or attributes corresponding to the stored conditions.

Determining if at least one condition has been met may include identifying metadata or a tag within the shipment plan that indicates a condition. A received shipment plan may include metadata or tags embedded within the shipment plan. A tag or metadata that is embedded within the shipment plan may correspond to a condition. In other words, a user, entity, and/or the like, could embed a tag or metadata corresponding to a condition within the shipment plan. The tag or metadata could specifically identify that a condition has been met within the shipment plan and that it needs to be modified. The tag or metadata could identify the modification that needs to be made, may include a link or pointer to the condition that has been met that then identifies the modification to be made, may include a link or pointer to software code that needs to be executed in order to make a modification, and/or the like. Thus, the metadata and/or tag does not have to identify the specific attributes or values of the shipment plan that need to be changed, that are forcing the modification, and/or the like. However, this information could be included in the metadata and/or tag.

The tag or metadata could be included or embedded in the shipment plan from the system that generated the shipment plan. Alternatively, the tag or metadata could be included or embedded within the shipment plan after it has been generated, but before it is received by the user or entity who will execute the shipment plan. Alternatively, the tag or metadata could be included or embedded within the shipment plan after it has been generated and after it is received by the user or entity who will execute the shipment plan, but before the user or entity has to make a manual change to the shipment plan. Tag or metadata embedding can also occur at a combination of times during the generation and transmission of the shipment plan. Thus, the tag or metadata embedding can be performed utilizing a variety of systems, for example, a system that generates the shipment plan, a system that validates the shipment plan, a system that receives the shipment plan, and/or the like. These systems may communicate with the shipment plan modification systems, may be different modules of the shipment plan modifications system, and/or the like.

Determining if at least one condition has been met may include utilizing the artificial intelligence model, rules engine, rules database, learning algorithm, and/or the like, to identify information contained within the shipment plan should be modified. In other words, the system may not specifically identify that attributes or values of the shipment plan correspond to a condition. Rather, the system may identify a correlation between shipment plan attributes or values and changes made to historical shipment plans with the same or similar attributes or values. Thus, the identified condition may be identifying that the shipment plan has similarities to historical shipment plans that were changed, where the similarities correspond to attributes or values that were changed.

In addition to making the identification of the condition using these techniques, the system can also create or generate conditions to be stored within the data storage location or data repository of conditions. In other words, utilizing the artificial intelligence model, rules engine, rules database, learning algorithm, and/or the like, the system may monitor manual changes to historical shipment plans and identify correlations between values of the historical shipment plans and the manual changes that were made and generate a condition based upon the correlation. For example, if the system identifies a pattern of the manual changes in relation to values or attributes of the shipment plan, the system may then generate a condition that identifies the values and attributes and the corresponding manual change as the result. As another example, if the system identifies a correlation between an attribute and a change, the system may then generate a condition that identifies the attribute and the corresponding change as the result.

If a condition has been met, regardless of the technique utilized to determine if a condition has been met, then the system determines that the shipment plan should be modified. If a condition has not been met, regardless of the technique utilized to determine if a condition has been met, then the system determines that the shipment plan does not need to be modified. It should be noted that other techniques for determining if a condition has been met are contemplated and possible. Additionally, a combination of techniques for determining if a condition has been met can be utilized in the same shipment plan. Thus, the described determinations are merely for illustrative purposes and are not intended to be limiting.

If, at 202, the shipment plan modification system determines that at least one condition has not been met within the shipment plan, the shipment plan modification system may take no action with respect to the shipment plan at 204. In other words, the system may present the shipment plan as it would normally be presented with no changes made to the shipment plan that was originally created. It should be noted that “no changes” refers to changes made automatically by the system. Manual changes can still be made by the user or other entity. If manual changes are made, the system may monitor these changes. The monitoring of these changes can be utilized by the system to determine if future automatic changes should be made to subsequent shipment plans based upon the manual changes. The monitoring of the changes may be performed using the artificial intelligence model to learn correlations between changes and the identification or generation of conditions, using a rules engine, using a database, and/or the like.

If, on the other hand at 202, the shipment plan modification system determines that at least one condition has been met within the shipment plan, the system may obtain software code corresponding to the at least one condition at 203. In other words, upon determining that a modification needs to be made to the shipment plan, the shipment plan modification system may obtain software code that corresponds to the at least one condition. The software code includes software code that is configured to modify the shipment plan. The software code may include code, a program, and/or the like, that is programmed to effectuate a modification to the shipment plan. For example, the software code may include microcode, a programming script, a small executable program, and/or the like, that can cause modifications to be made to the shipment plan.

The software code may be stored within a software code repository. In this case, the condition that was identified as being met may also identify the location of the software code that should be utilized to make the change identified by the condition. Thus, the condition may include a link, pointer, location identifier, and/or the like, that allows the shipment plan modification system to identify what software code needs to be executed to make the change, to identify a location of the software code that needs to be executed, and/or the like. Alternatively, or additionally, the condition may include the software code that needs to be executed to make the modification. In other words, the condition may be stored within a data repository and the software code may be stored in the same data repository and linked to the condition. Thus, when the condition is identified, the software code can be accessed and executed without having to access a different data repository. The software code may also be included in the shipment plan itself. For example, in the case that a tag or metadata is embedded within the shipment plan, the tag or metadata could include the software code that effectuates the modification to the shipment plan. Thus, the tag or metadata that is embedded may not, but it could, identify the condition, but rather simply include the code that effectuates the modification.

The software code could be generated utilizing one or more software code generation techniques. In one technique, the software code could be created by a user, software code programmer, and/or the like. In this case, the shipment plan modification system could communicate that software code needs to be generated for conditions and modifications. The system can monitor changes to shipment plans. Upon identifying a correlation between attributes or values and changes, the system can notify a code developer (e.g., a particular person, a group of users, etc.), that code needs to be generated. In this notification, the system can identify the conditions or attributes that have been identified as corresponding to a particular modification. Once the software code has been developed, it can be stored in an accessible location and then accessed by the shipment plan modification system in order to effectuate modifications to subsequent shipment plans.

The notification presented to the user to generate the code may be any type of notification (e.g., audible notification, notification provided within an application, notification provided over a communication medium (e.g., smart phone, pager, instant message, video conferencing software, email, etc.), visual notification, pop-up notification, etc.) using any type of notification modality (e.g., audible, visual, haptic, electromyography, etc.). The notification may include all of the information within the notification or may require the user to select the notification to see additional information, require the user to access a particular application to see additional information, and/or the like.

The software code may also be generated automatically by shipment plan modification system. The system may identify the historical modifications that have been made to the historical shipment plans and identify correlations therebetween. Upon identifying the correlations, instead of (or in addition to), notifying a user or software developer of the need to generate the software code, the system may automatically generate the software code. To generate the code, the system may utilize an artificial intelligence model that has been programmed to generate software code. The model can take as input the identified attributes or values that have been identified as corresponding to the modification and also the resulting modification. The model can analyze and process this input and then create and provide, as output, software code that would effectuate the modification to shipment plans when the condition has been met. The generated software code can be stored within the data repository for access by the shipment plan modification system.

In automatically generating the software code, the system may request that a user approve the generation of the code before it is generated by the system. In other words, a user could validate that code should be generated. Alternatively, the system may simply automatically generate the code without needing user approval to do so. Whether the system needs approval to generate the code or not may be dependent on the type of modification that is to be made, may be dependent upon the shipment plans to which the modification will be made, may be dependent on particular attributes of the shipment plan that will be modified, and/or the like. These settings could be set as default settings, configured by a user, learned by the system over time, and/or the like. Similarly, before the automatically generated code is stored, it may need to be validated by a user. A similar validation may occur.

Once the software code has been obtained, the shipment plan modification system may automatically modify the shipment plan by executing the software code at 205. In other words, the shipment plan modification system automatically executes the software code that corresponds the condition that was met and the execution of this software code causes the shipment plan to be modified automatically without the user or receiver of the shipment plan having to make the manual modification to the shipment plan. The modification to the shipment plan can occur before the shipment plan receiver has seen the shipment plan. Thus, when the shipment plan receiver sees the shipment plan the change has already been made, thereby eliminating the need for the shipment plan receiver to make the modification.

In addition to modifying the received shipment plan, the system may also automatically modify other shipment plans that are affected by the modification. In other words, automatically modifying the shipment plan may include automatically modifying one or more additional shipment plans in addition to the shipment plan based upon the execution of the software code. Some shipment plans may be dependent upon other shipment plans. For example, a second shipment plan may utilize the same transporter, so a change to one shipment plan may require a change to the subsequent shipment plan. In this case, the system can automatically make the change to the subsequent shipment plan. Similarly, if the received shipment plan is dependent on a previous shipment plan, a change to the subsequent shipment plan may require a change to the previous shipment plan. Thus, the system can automatically make the change to the previous shipment plan.

In addition to shipment plan dependencies, the system can also identify multiple shipment plans that need the same modification. The system can then make modifications to all of these shipment plans. Additionally, changes to shipment plans may result in modifications to a number of shipment plans. For example, some modifications may result in a single shipment plan being changed to multiple shipment plans or multiple shipment plans being changed to a single shipment plan. For example, a change in a length of time to run a route may result in multiple transporters needing to be used to get the objects to a destination location on time. Accordingly, the shipment plan may need to be changed to multiple shipment plans, with each transporter having responsibility for one of the multiple shipment plans. As another example, a change to a transportation vehicle type may result in objects from multiple shipment plans being able to be transported on a single transportation vehicle, thereby allowing the multiple shipment plans to be combined to a single shipment plan. Modifications to multiple shipment plans can be made sequentially, simultaneously, or a combination thereof.

As an overall, non-limiting example, a shipment plan receiver may receive a shipment plan that is directed to a specific receiver. The master data that was used to generate the shipment plan identifies that the destination has off-loading hours that are from 9am – 5pm every week day. However, the shipment plan receiver knows that on Thursdays, the receiver always leaves early and shipments can only be offloaded until 3pm. Assuming that the shipment plan has an offloading day of Thursday and an offloading time of 4pm, the shipment plan receiver makes a change to the shipment plan indicating that the offloading time is 2pm, instead of 4pm. The shipment plan modifications monitors this change, and notes that in this shipment plan and previous shipment plans there is a correlation of changes being made to the shipment plan for this receiver on Thursdays that move the offloading time to before 3pm. Accordingly, the shipment plan modification system identifies that Thursdays for this receiver after 3pm are the values and attributes to a condition and the result corresponding to the condition is a modification to the shipment plan where the offloading time is moved to before 3pm. The code for effectuating this modification is generated, either by a user or automatically by the system, and stored within an accessible data repository.

Thus, upon receiving a subsequent shipment plan having an offloading day of Thursday and after 3pm for this receiver, the shipment plan modifications system identifies the condition is met, obtains the software code that effectuates the modification to the shipment plan, and then executes the software code. Thus, the shipment plan is automatically modified to change the offloading time to before 3pm on Thursday for this receiver. Additionally, the system modifies any other portions of the shipment plan that need to be changed in order to account for this modification, for example, a pickup time, a change in a route to arrive at the destination for the new offloading time, an available transporter, and/or the like. Additionally, if any other shipment plans need to be modified due to the modification to this shipment plan, the system effectuates those modifications also. For example, if the transporter is scheduled to execute another shipment plan after executing this shipment plan, the subsequent shipment plan may need to be modified based upon the change in offloading time.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated. Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
receiving, utilizing a shipment plan modification system, a shipment plan, wherein the shipment plan comprises at least one transportation order for at least one object;
identifying, utilizing the shipment plan modification system, at least one condition is being met within the shipment plan, wherein the at least one condition indicates the shipment plan needs to be modified;
obtaining, utilizing the shipment plan modification system, software code corresponding to the at least one condition, wherein the software code comprises software code that is configured to modify the shipment plan; and
automatically modifying, by executing the software code, the shipment plan.

2. The method of claim 1, wherein the identifying of the at least one condition comprises identifying that a tag corresponding to a condition is embedded within the shipment plan.

3. The method of claim 1, wherein the identifying of the least one condition comprises comparing values contained within the shipment plan to values corresponding to conditions.

4. The method of claim 1, wherein the identifying of the at least one condition comprises accessing a data storage location comprising a plurality of conditions and identifying the shipment plan has an attribute meeting the at least one condition from the plurality of conditions.

5. The method of claim 1, wherein generating the at least one condition comprises monitoring manual changes to historical shipment plans and identifying correlations between values of the historical shipment plans and the manual changes.

6. The method of claim 1, wherein the software code comprises software code automatically generated by the shipment plan modification system based upon historical modifications made to historical shipment plans.

7. The method of claim 1, wherein the software code comprises software code generated by a user in response to receiving a notification from the shipment plan modification system that software code corresponding to a shipment plan modification is needed.

8. The method of claim 1, wherein the automatically modifying comprises automatically modifying at least one additional shipment plan in addition to the shipment plan based upon the executing of the software code.

9. The method of claim 1, wherein the software code comprises microcode.

10. The method of claim 1, wherein the obtaining of the software code comprises accessing a software code repository.

11. A system, the system comprising:
a processor;
a memory device that stores instructions that, when executed by the processor, causes the system to:
receive, utilizing a shipment plan modification system, a shipment plan, wherein the shipment plan comprises at least one transportation order for at least one object;
identify, utilizing the shipment plan modification system, at least one condition is being met within the shipment plan, wherein the at least one condition indicates the shipment plan needs to be modified;
obtain, utilizing the shipment plan modification system, software code corresponding to the at least one condition, wherein the software code comprises software code that is configured to modify the shipment plan; and
automatically modify, by executing the software code, the shipment plan.

12. The system of claim 11, wherein the identifying of the at least one condition comprises identifying that a tag corresponding to a condition is embedded within the shipment plan.

13. The system of claim 11, wherein the identifying of the least one condition comprises comparing values contained within the shipment plan to values corresponding to conditions.

14. The system of claim 11, wherein the identifying of the at least one condition comprises accessing a data storage location comprising a plurality of conditions and identifying the shipment plan has an attribute meeting the at least one condition from the plurality of conditions.

15. The system of claim 11, wherein generating the at least one condition comprises monitoring manual changes to historical shipment plans and identifying correlations between values of the historical shipment plans and the manual changes.

16. The system of claim 11, wherein the software code comprises software code automatically generated by the shipment plan modification system based upon historical modifications made to historical shipment plans.

17. The system of claim 11, wherein the software code comprises software code generated by a user in response to receiving a notification from the shipment plan modification system that software code corresponding to a shipment plan modification is needed.

18. The system of claim 11, wherein the automatically modifying comprises automatically modifying at least one additional shipment plan in addition to the shipment plan based upon the executing of the software code.

19. The system of claim 11, wherein the obtaining of the software code comprises accessing a software code repository.

20. A product, the product comprising:
a computer-readable storage device that stores executable code that, when executed by a processor, causes the product to:
receive, utilizing a shipment plan modification system, a shipment plan, wherein the shipment plan comprises at least one transportation order for at least one object;
identify, utilizing the shipment plan modification system, at least one condition is being met within the shipment plan, wherein the at least one condition indicates the shipment plan needs to be modified;
obtain, utilizing the shipment plan modification system, software code corresponding to the at least one condition, wherein the software code comprises software code that is configured to modify the shipment plan; and
automatically modify, by executing the software code, the shipment plan.
